(19) United States
(12) Patent Application Publication
(10) Pub. No.: US 2007/0093932 A1
(43) Pub. Date: Apr. 26, 2007

(54) AUTOMATICALLY PROGRAMMABLE DISPENSING APPARATUS AND METHOD

(75) Inventors: Gazi Abdulhay, Allentown, PA (US); Ali Abdulhay, Allentown, PA (US)

Correspondence Address: DESIGN IP, P.C., 5100 W. TILGHMAN STREET, SUITE 205, ALLENTOWN, PA, 18104, US

(73) Assignee: ANTIOCH HOLDINGS, INC., Wilmington, DE (US)

(21) Appl. No.: 11/559,213

(22) Filed: Nov. 13, 2006

Related U.S. Application Data
(63) Continuation-in-part of application No. 11/088,385, filed on Mar. 23, 2005.
Application No. 11/088,385 is a continuation-in-part of application No. 10/438,452, filed on May 14, 2003, now Pat. No. 7,048,141.
(60) Provisional application No. 60/378,105, filed on May 14, 2002.

(51) Int. Cl. G06F 17/00

(52) U.S. Cl. 700/231

(57) ABSTRACT

A pill dispensing apparatus to select medication from one or more pill chambers, including a dispensing mechanism, a controller and a computer. Each pill chamber includes media containing dosage and other information regarding the medication in the pill chamber and, optionally, personal medical data. A sensor reads the stored information and provides it to the computer and controller, causing the dispensing mechanism to dispense pills from the respective pill chambers based on the stored information.

### CROSS-REFERENCE TO RELATED APPLICATIONS

This application is a continuation-in-part of U.S. patent application Ser. No. 11/088,385, filed Mar. 23, 2005, which is a continuation-in-part of U.S. patent application Ser. No. 10/438,452, filed May 14, 2003, now issued as U.S. Pat. No. 7,048,141, which claims the benefit of U.S. Provisional Application No. 60/378,105, filed May 14, 2002, all of which are hereby incorporated into this application by reference as if fully set forth.

### FIELD OF THE INVENTION

This invention relates generally to medication dispensers, and more particularly, to dispensers having the ability to dispense solid pill medications on a user programmed schedule.

### BACKGROUND

U.S. application Ser. No. 11/088,385 discloses a pill dispensing apparatus that dispenses solid formed pills according to a pre-programmed schedule. A means for storing a multitude of different pills in chambers is disclosed along with a dispensing means for mechanically dispensing the pills into a dispensing cup, i.e., an exit port. However, the pre-programmed schedule requires manually inputting the scheduling information via a keyboard which is a time consuming process.

It would be desirable for dosage and scheduling information such as dosage amounts, frequencies and times, to be automatically programmed into the pill dispenser for each of the medications contained in the pill dispenser and for the pill dispenser to act in accordance with the automatically programmed schedule. It would also be desirable for information such as patient's name, address, telephone number, prescribing doctor, pharmacy, pharmacy identification number, prescription number, FDA identifier number, date issued, expiration date, manufacturer, number of refills, use-before date, special instructions and other data to be provided and/or updated without having to manually program each entry. In particular, it would be desirable to provide a pill dispensing apparatus in which such information need not be manually programmed and updated.

Thus there is a need for an improved medication dispenser which is automatically and remotely programmed with medication dosage, scheduling and other information.

### SUMMARY OF THE INVENTION

To address these and other needs and in view of its purposes, the present invention provides a pill dispenser having at least one pill chamber, means for extracting pills from the pill chambers and placing the pills into an extraction port, a sensor, and a computer capable of storing data received from the sensor. At least one of the pill chambers has attached thereto a media that is read by the sensor.

In another aspect, the invention provides a method for dispensing pills from a pill dispenser. The method includes providing a pill dispenser with at least one pill chamber, a dispensing mechanism, a computer, a sensor, and a media coupled to each pill chamber. The method further provides the sensor reading dosage schedule information from each media and forwarding the dosage schedule information to the computer. The computer then communicates with a controller and the method further provides the controller causing the dispensing mechanism to dispense pills in accordance with the dosage schedule information, the dispensing mechanism removing at least a pill from one of the pill chambers and delivering the pill to an exit port.

### BRIEF DESCRIPTION OF THE DRAWINGS

The present invention is best understood from the following detailed description when read in conjunction with the accompanying drawing. Like numerals denote like features throughout the specification and drawing.

FIG. 1 is a top plan view of the pill dispensing apparatus according to the invention, shown with the dispensing platform and devices mounted thereon removed;

FIG. 2 is a front elevation view take alone line 2-2 of FIG. 1 and including the dispensing platform and devices mounted thereon;

FIG. 3 is a perspective view of the dispensing platform;

FIG. 4 is a top plan view thereof;

FIG. 5 is an exploded perspective view of a dispensing chamber in relation to a portion of the apparatus of FIG. 1;

FIG. 6 is a chart of information stored on a bar code of the invention;

FIG. 7 is a schematic representation of the steps for filling a pill dispensing chamber;

FIG. 8 is a partial front elevation view partially in section of a vacuum dispensing device according to the present invention;

FIG. 9 is an electrical block diagram of the pill dispensing apparatus of FIG. 1;

FIG. 10 illustrates the parsing of the dispensing command from the single board computer to the microcontroller;

FIG. 11 is a flow chart that illustrates the microcontroller interrupt control algorithm for automatically and remotely reading the data from each dispensing chamber;

FIG. 12 is a flow chart of a control algorithm for dispensing a single pill medication;

FIG. 13 is a partial front elevation view partially in section of the vacuum dispensing system according to the invention shown engaging a granular pill; and

FIG. 14 is a partial front elevation view partially in section of another dispensing assembly according to the present invention.

### DETAILED DESCRIPTION

The present invention is a pill dispensing apparatus with a data storage medium, or “media,” which can be automatically read by the pill dispenser to provide or update information relating to the medication contained in a pill chamber and/or the person for whom the medication is intended. Such information may be stored in an on-board computer which communicates with a dispensing mechanism of the pill dispensing apparatus via a controller. The apparatus of the invention dispenses medication responsive to information provided by the computer.

The pill dispensing apparatus includes a plurality of removable and interchangeable containers, each container including a pill chamber. Each container includes an associated media located thereon that can be remotely read by the dispenser. The media can be a simple one dimensional bar code for storing a small amount of data or it can be a two-dimensional bar code for storing larger amounts of data. At a minimum, the data preferably contains the dose and dispensing schedule for the pills that have been loaded into the pill chamber, i.e. dosage amount, dosage time and dosage frequency. Other information which may be stored on the media includes the patient's name, address, telephone number, prescribing doctor, pharmacy, pharmacy identification number, prescription number, FDA identifier, date issued, expiration date, manufacturer, number of refills, use-before date, and special instructions to be followed when taking the medication. The data described in this paragraph is collectively referred to herein and in the claims as “dosage information.”

In another respect, the pill dispensing apparatus includes a cylindrically shaped base unit having one or more removable pill dispensing containers radially aligned along the outer circumference of the base. Each pill dispensing container may have a sealable removable top which protects the pills from air borne contaminants. Each pill dispensing container may include a vertically positioned pill storage chamber for storing a large number of pills which then transitions to a lower dispensing chamber. A portion of the lower dispensing chamber partially protrudes towards the center of the base. The transition region between the pill storage and dispensing chambers is inwardly sloped to guide the pill medication towards the protruding portion of the dispensing chamber. The top portion of the dispensing chamber has an access opening which allows internal access to the pill medication. The access opening has a removable seal which, along with the sealable removable top, protects the medication from the surrounding environment and allows for the shipment of a previously-filled pill dispensing container to the user, while maintaining the medication in a sterile condition. The described arrangement is intended to be exemplary.

Each container may include a media which can be remotely accessed and read by an interface that is part of the pill dispenser apparatus. The media could be a one dimensional bar code, a two dimensional bar code, an RFID tag or other machine-readable data storage media, depending upon the amount of information desired to be stored thereon. In this case, the interface would be a bar code reader. The media may be affixed to the container and is preferably pre-programmed with dosage information when the medication is introduced into the pill chamber.

The containers are arranged around the circumference of the base and are configured to provide internal access to pill medication stored within each container. Additionally, at least one vibrating motor may be mounted on the base to gently vibrate the containers and assist pill movement from the storage chamber to the dispensing chamber. Further disposed at each container location is a limit switch which closes when a container has been inserted into the base and opens when a container has been removed from the base. Solenoid latches engage and lock each container into the base unit (referred to as a “locked position”), preventing the removal of the container during solenoid activation.

Axially mounted within the interior of the base is a disk shaped rotating platform which may be powered by a set of gears and a first DC motor. As the platform rotates, a partially pie shaped hole located on the periphery of the platform allows access through the hole and into each dispensing chamber to access the respective pill medication. The rotating platform also has a media reader which can access and read the data previously stored within each media located on the containers.

Other arrangements may be used in other embodiments. For example, the media reader, i.e. sensor, may be movable to read the data storage devices fixed to, or associated with the containers, using other mechanical arrangements.

Also fixed to the base unit is a bar coded semi-reflective strip having reflective and non-reflective stripes. The pattern of stripes forms a unique code to identify each pill dispensing chamber location. Further attached to the rotating platform is an infra-red optical emitter and detector pair which cooperatively communicate with the bar coded semi-reflective strip. As the platform rotates with respect to the base unit, the infra-red emission from the optical transmitter is either reflected or absorbed by the semi-reflective strip. The reflection from the strip is received by the optical detector which then produces an electrical signal corresponding to the bar code of each container. The electrical signal represents the relative position of the platform and therefore the dispensing mechanism, with respect to each pill dispensing container. Other position indicators may be used in other embodiments.

In one embodiment, the dispensing mechanism includes a DC powered suction pump having an inlet port in fluid communication with an outlet port mounted on top of the rotating platform. When the vacuum pump is powered on, a vacuum is produced at the inlet port. The inlet port then connects to a flexible conduit attached to the top of the pill dispensing assembly which, in turn, is connected to the inlet port of a solenoid operable fluid switch. The outlet port of the fluid switch is in fluid communication with the atmosphere.

Powering the solenoid establishes fluid communication between the atmosphere and the conduit which drastically reduces any vacuum present in the conduit. Further connected to the flexible conduit is the inlet port of a pressure transducer. The pressure transducer produces an electrical signal indicating the presence or absence of a vacuum in the flexible conduit.

This dispensing assembly further comprises a vertically positioned rigid conduit in fluid communication with the aforementioned flexible conduit at the upper end and in fluid communication with a flexible silicon bellows at its lower end. A vertically based moveable sheath is concentrically located over the rigid conduit with the bellows extending beyond the lower portion of the rigid conduit. A third limit switch is positioned above the sheath and closes when the sheath reaches the uppermost vertical position.

The pill dispensing assembly is fixed to a vertically moveable rack which further engages a pinion gear powered by a second DC motor. The pill dispensing assembly is located over the access aperture of the rotating platform. Thus the dispensing assembly can move in either an upward or downward direction through the platform access aperture as determined by the direction of rotation of the second DC motor. Limit switches are further placed at the furthermost vertical top and bottom dispensing assembly positions to close when the assembly reaches either of these positions.

A controller is provided which interfaces with all of the limit switches, pressure transducer, vacuum motor, table rotation first DC motor, vibration motors, dispensing second DC motor, opto-emitter and detector, solenoid valve, solenoid locking latches, and dispensing container switches. The controller is also in electrical bidirectional communication with a single board or other computer. The computer is in communication with a touch screen, liquid crystal display (LCD) or other programming means such as a conventional keyboard.

The dispensing mechanism described above is intended to be representative of the invention only and the media provided in the pill dispensing mechanism which may be associated with each of multiple containers may be used in conjunction with pill dispensers of various configurations that dispense pills using any other dispensing mechanism configurations.

A user may program the controller, via the computer, with a dispensing schedule by entering data specifying the container number, pill medication type, quantity of pills to be dispensed from the respective pill chamber and the time for dispensing the medication, through an interactive dialog using an LCD touch screen, keyboard or other suitable and available input and display device. Alternatively or additionally, the dispensing and dosage information may be automatically read from media located on each container by an interface (such as a bar code reader) and provided to the computer. In one embodiment, after the dosage and dispensing information is manually programmed by a user using programming means as described above, the manually programmed dispensing and dosage date may be overridden by the automatically read data from the media.

If the dispensing schedule is manually entered by the user, the computer controls the user interface through the interactive dialog and creates the dispensing schedule. According to another embodiment, manual programming by the user may not be needed, i.e. if the dosage and dispensing information is provided solely by the media. In the embodiment in which a user programs the information manually, once the user has finished entering the dispensing schedule information, the computer then parses the dispensing schedule into a more basic schedule individually listing each time for dispensing an individual pill from a selected chamber. When the time for dispensing the medication occurs, the computer sends the controller a single pill dispensing command for dispensing only a single pill from an identified chamber. If more than one pill from the same chamber is required, another single pill dispensing command is repeated until the correct number of pills has been dispensed for the selected pill type. This procedure is continued until all the required pills from their respective chambers have been successfully dispensed.

If the dispensing information is automatically obtained from reading a media from each dispensing container, this information is first sent to the computer which then parses the dispensing schedule into a more basic schedule individually listing each time for dispensing an individual pill from a respective chamber.

When the time for dispensing the medication occurs, the computer again sends the controller, which may be a microcontroller, a single pill dispensing command for dispensing only a single pill from a selected chamber. If more than one pill from the same chamber is required, another single pill dispensing command is repeated until the correct number of pills has been dispensed for that particular pill type. This procedure is continued until all the required pills from their respective chambers have been successfully dispensed.

The dispensing mechanism that receives the signals from the computer and controller combination and dispenses a pill responsive to the signal may employ other mechanical arrangements. According to one embodiment, a controller, in response to a single dispensing command, directs the dispensing assembly to the uppermost position as indicated by closing of the uppermost limit switch. The controller directs the platform to rotate until the opto-circuitry indicates that the platform access aperture is over the correct pill chamber. The controller then activates the vacuum pump and vibrating motors and lowers the dispensing assembly through the platform access aperture into the pill chamber. If the flexible bellows engages a pill, a vacuum will occur in the fluid circuit. In response to the vacuum, the pressure transducer sends a signal to the controller indicating that a pill has been picked up by the bellows. The controller then raises the dispensing assembly and moves the platform over a release tray. The solenoid switch is activated removing the vacuum from the fluid circuit and releasing the pill. The pill falls into the exit or release tray, also referred to herein as an exit port. If a pill is not picked up, either the sheath switch or the lowermost limit switch signals the controller. In response to either the sheath or lower limit switch signal, the controller raises the dispensing assembly until the uppermost limit switch signals the controller. The controller again repeats the dispensing procedure for a number of attempts. In subsequent attempts, the platform is preferably rotated a small amount, in order to vary the location of the dispensing assembly when it is lowered into the pill chamber.

The controller activates the solenoid latches locking each container into position preventing the user from removing the containers during the entire dispensing cycle. In addition, the computer may include a drug interaction database and be programmed to identify any drug interactions, based on data read from the media.

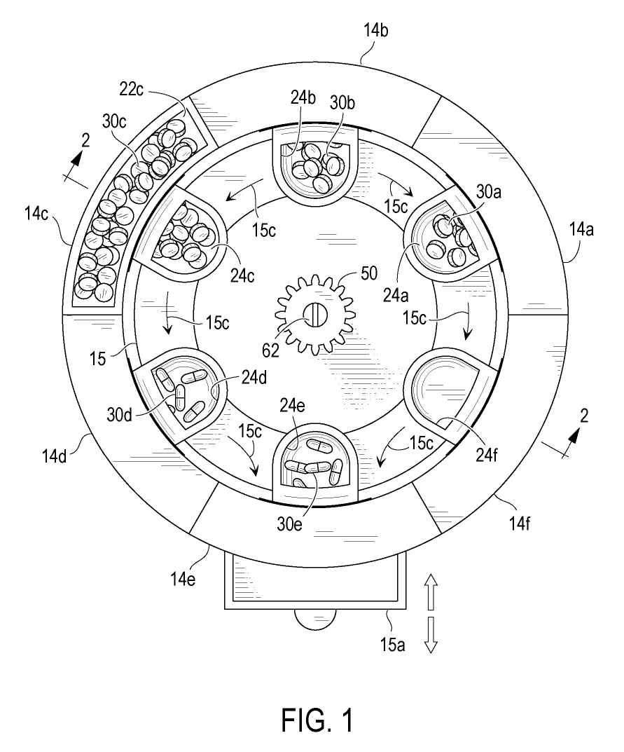

Referring to FIGS. 1 & 2, pill dispenser 1 is generally representative of an embodiment of the present invention. Pill dispenser 1 comprises a support base 10 that is generally cylindrical in shape and is designed to support a plurality of containers thereon. In this embodiment, six identical containers 14a, 14b, 14c, 14d, 14e, 14f are provided. The base 10 can support any desired number of containers, depending upon the number of medications required by a user. Removable pill dispensing containers 14a, 14b, 14c, 14d, 14e, 14f are radially aligned along the circumference of base 10.

In order to simplify the description of the containers 14a, 14b, 14c, 14d, 14e, 14f, the features of container 14c and portions of the pill dispenser 1 that are provided for each container 14a, 14b, 14c, 14d, 14e, 14f will be described herein in relation to container 14c. For example, a mounting groove 12c is provided to accept and hold pill dispensing container 14c. Although not specifically referred to herein, it is to be understood that corresponding mounting grooves 12a, 12b, 12d, 12e, 12f are also provided for containers 14a, 14b, 14d, 14e, 14f. Where possible, portions of the pill dispenser 1 that are also provided for containers 14a, 14b, 14d, 14e, 14f will be shown in the drawings, but may not be specifically referred to in the specification.

The base 10 also includes a switch 700c, which is pivoted to a closed position when container 14c is completely inserted into the base 10. Switch 700c is electrically connected to printed circuit board 68 by conventional electrical conduits.

As used herein and in the claims, the term “pill” is intended to mean all types of dietary supplements and pharmaceuticals that are provided in solid form or in any form contained in a semi-solid outer surface and are intended to be swallowed whole or by chewing including, for example, pills, tablets, capsules, caplets, chewables and the like.

The container 14c includes a pill chamber having a vertically-aligned storage portion 22c and horizontal dispensing portion 24c. The pill dispensing chamber has the capacity to hold a large quantity of loose, randomly-oriented pills 30c, preferably of a single type. For example, pill dispenser 1 can have six peripherally disposed pill dispensing chambers and is thus capable of dispensing six different types of medication. However, the number of chambers can be increased by using a larger base 10 and radially aligning more dispensing chambers having greater circumference around the base 10 or by re-sizing the pill dispensing chambers. A transition region 26c, between portions 22c and 24c of the dispensing chamber, is formed to guide the pills 30c from portion 22b to portion 24a using the force of gravity.

Each container is formed for interlocking with all other containers mounted radially onto the outer circumference of base 10 such that the entire pill dispenser 1 has a cylindrically shaped outward appearance. The top of the container 14c is open or contains an aperture or opening to permit access to pills contained within chamber portion 22c. To protect the pills from dust and other air borne contaminants, the dispensing chamber is preferably fitted with a removable lid 16c.

Base 10 contains a cylindrically shaped support 13 axially aligned with a central axis of base 10. Support 13 extends past surface 18c of containers 14c. Fixed to support 13 is stationary gear 50. As previously described, semi-reflective strip 112 is placed over or on the top surface of gear 50.

A solenoid 890c, having a corresponding moveable plunger 891c is positioned below the container 14c in the base 10. When the solenoid 890c is activated, the plunger 891c is forced in an upward (locked) position, engaging corresponding apparatus 892c in the container 14c, thereby preventing the removal of the container 14c from the base 10. The solenoid 890c is connected to printed circuit board 68 via suitable electrical conduits and may be actuated into locked position by a signal from the single board computer when corresponding switch 700c is closed, or in response to another input. The container 14c is preferably locked into position after a media located on the container 14c is read by a sensor and a dose and dispensing schedule for that container 14c is sent to a controller, as will be described in greater detail herein.

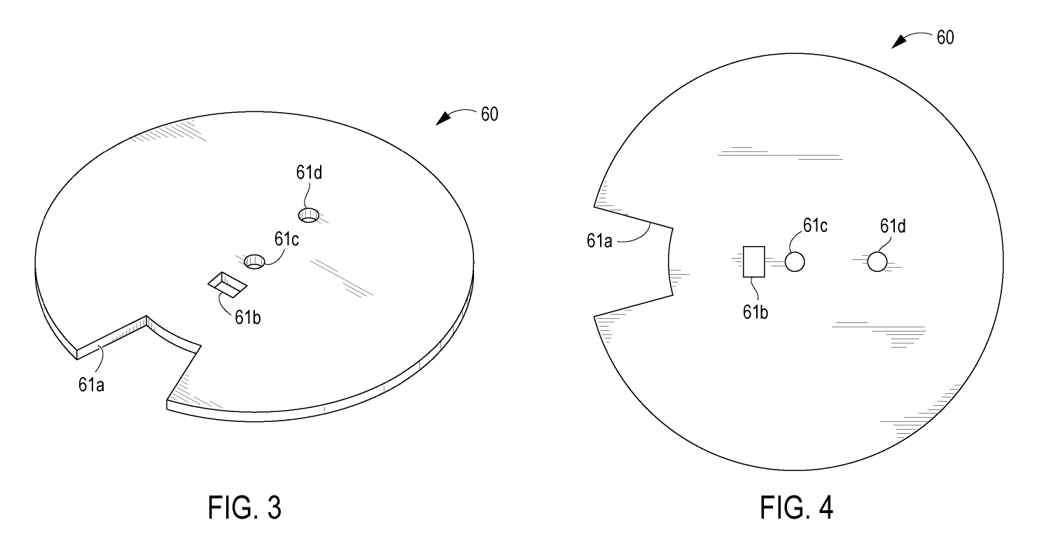

Referring to FIGS. 3 and 4, cylindrically shaped dispensing platform 60 is rotatably attached to support 13 by pin 62. Platform 60 has a pie shaped dispensing aperture 61a, a rectangularly shaped optical access aperture 61b and an axially positioned mounting aperture 61c.

Referring again to FIGS. 1 & 2, fixed to the top side of platform 60 is electric motor 63. The shaft 63a of motor 63 protrudes through platform 60 through aperture 61d and is attached to pinion gear 64 which is designed to mesh with gear 50. The diameter of gear 64 is less than the diameter of gear 50 increasing the drive torque produced by motor 63 and also rotating platform 60 at a rotational velocity less than the motor shaft rotational velocity. Motor 63 is further electrically connected to printed circuit board 68. Printed circuit board 68 is mounted to platform 60 and rotates along with platform 60. Motor 63 can rotate platform 60, and therefore, board 68.

Attached to platform 60 is suction pump 70 having an inlet port 72 and outlet port 74. Power for pump 70 is provided by motor 71. Inlet port 72 is in fluid communication with tube 76. Attached to tube 76 is solenoid valve 78 having an inlet port 79a and an outlet port 79b. Inlet port 79a is in fluid communication with tube 76. Solenoid valve 78 connects to printed circuit board 68. The outlet port 79b is in fluid communication with the surrounding atmosphere. The free end of tube 76 connects to and is in fluid communication with one end of pressure transducer 80. The other end of pressure transducer 80 is connected to and is in fluid communication with tube 82. The free end of tube 82 is connected to dispensing conduit 90. A flexible silicon bellows 92 is inserted into the free end of conduit 90. Connected to conduit 90 is suction cup assembly 91. Bellows 92, conduit 90, tube 82, transducer 80, tube 76, inlet port 72, outlet port 74 and pump 70 form a fluid circuit in communication with each other.

Conduit 90 is vertically supported by vertically moveable rack 94. Rack 94 is positioned to engage a corresponding pinion gear 96. Pinion 96 is fixed to shaft 97 of DC motor 98. Motor 98 is attached to platform 60 via support 99. Motor wires 98a and 98b connect to printed circuit board 68.

Limit switches 100 and 102 are preferably fixed to platform 60 by a bracket (not shown). These switches engage rack 94 at the ends of the vertical travel of rack 94 with switch 100 engaged at the uppermost end of travel and switch 102 engaged at the lower most end of travel. Switches 100 and 102 are also electrically connected to printed circuit board 68 via suitable electrical conduits.

Optional vibrating motors 105 and 107 can be mounted on the bottom of base 10. Motor 105 is electrically connected to printed circuit board 68 via wires 105a and 105b. Motor 107 is electrically connected to printed circuit board 68 via wires 107a and 107b. Vibrating motors 105 and 107 should be sized to vibrate base 10 and all containers 14.

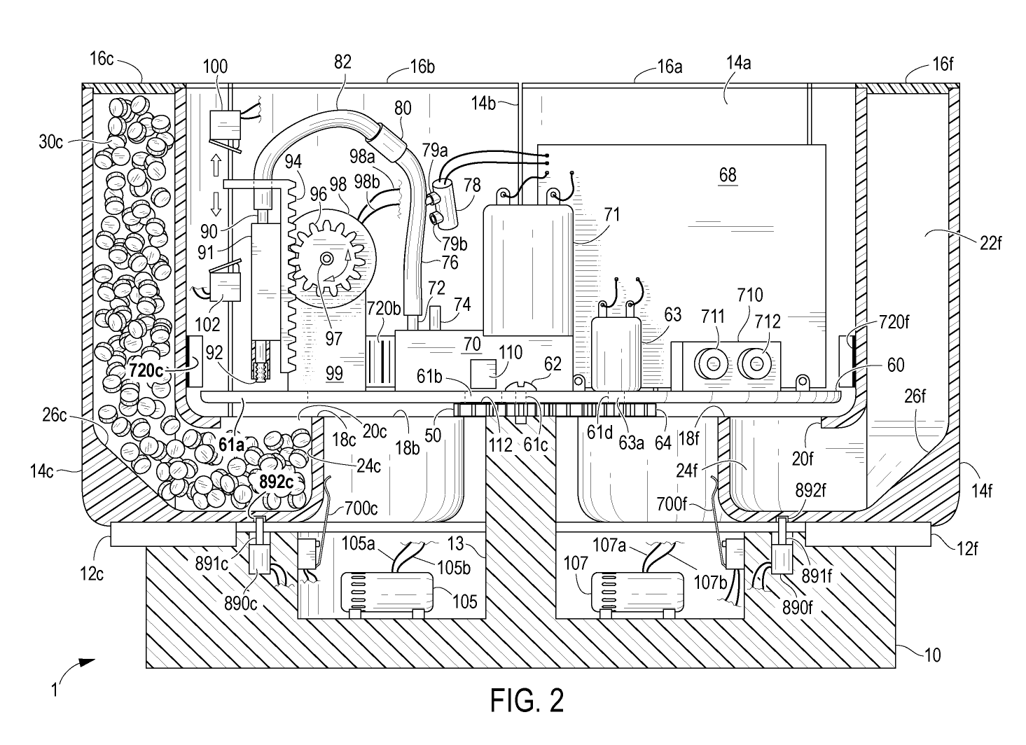

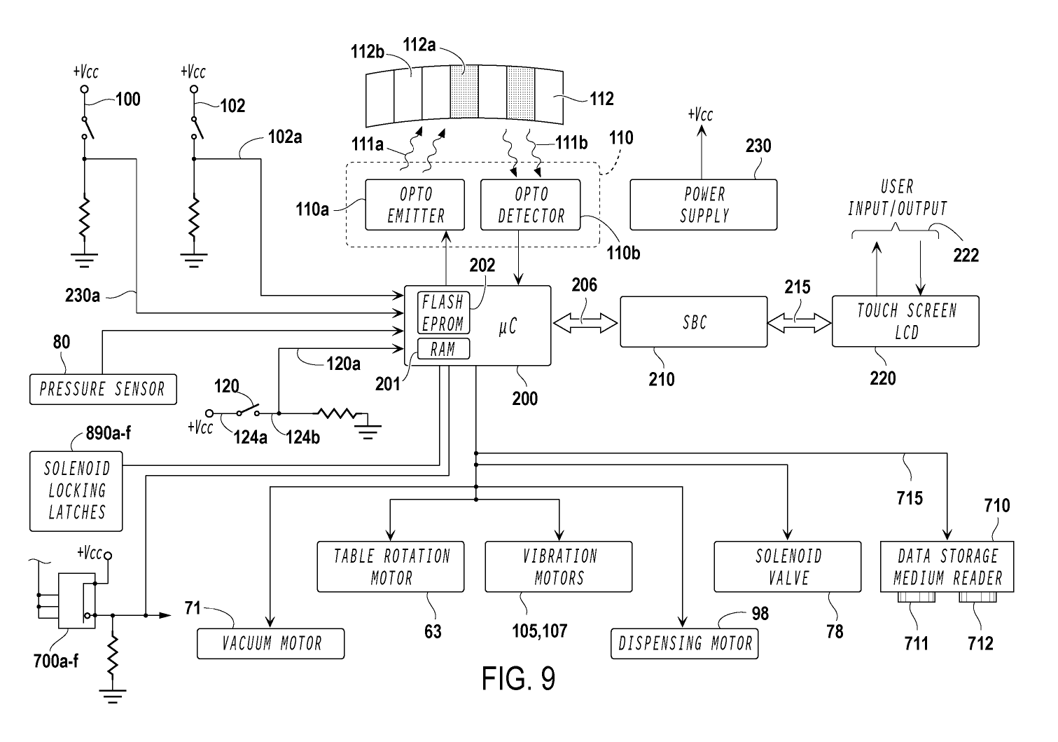

An infrared optical emitter and detector module 110 is attached to platform 60 and positioned over gear 50, so that module 110 is in optical communication through aperture 61b with semi-reflective strip 112. Module 110 reads semi-reflective strip 112 and is in electrical communication with board 68 which includes a computer (shown schematically in FIG. 9; not shown in FIGS. 1 and 2) that distinguishes the rotational position of platform 60, and therefore, which pill storage chamber portion 24a, 24b, 24c, 24d, 24e, 24f is located below the dispensing aperture 61a.

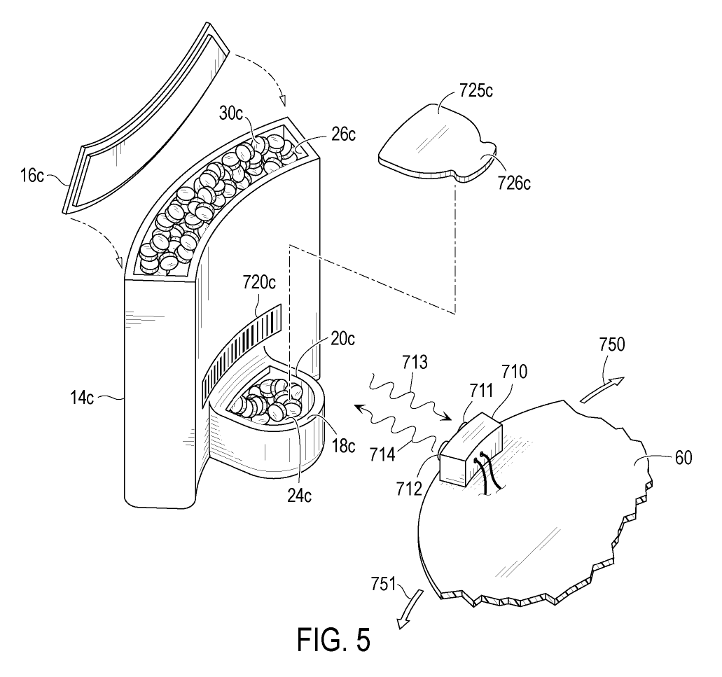

As shown in FIG. 5, reader 710 is an infrared, two-dimensional bar code reader having laser emitter 711 and detector 712 and is mounted on platform 60. Reader 710 is positioned on platform 60 so that media 720c, located on the inward facing surface of pill chamber 14c can be reliably read by reader 710. Reader 710 is further connected to the computer via suitable electrical connection. In this embodiment, media 720c is a one- or two-dimensional bar code. As explained above, media 720c could, alternatively, be any type of machine-readable media. Similarly, other types of readers or sensors could be substituted for reader 710, depending upon the type of media used on the containers. In addition, the pill dispenser 1 could be provided with multiple types of readers, which would enable the dispenser 1 to accommodate more than one type of media.

Alternatively, the media 720c could comprise a flash-memory device. In this case, the reader 710 would consist of a connector that is adapted to receive the flash-memory device and a bus interface (such as a serial or USB interface) that is connected to the computer. As used herein and in the appended claims in the context of transferring data from the media to the computer, the term “interface” is intended to include both sensors and readers which read the machine-readable data from the media without any physical connection between the sensor/reader and the media, as well as serial and USB interfaces, which translate and transmit data from the media to the computer.

Removable seal 725c may be attached to surface 18c during shipment of container 14c and removed prior to inserting container 14c into base unit 10. Tab 726c assists in the manual removal of seal 725c. It is further understood that platform 60 can rotate either in clockwise direction or counterclockwise direction shown by arrows 750, 751 respectively. Also shown is media 720c which, in one embodiment, can be a two-dimensional bar code. Reader 710 emits an infrared laser emission shown by arrow 714 which is focused onto two-dimensional bar code 720c, producing a reflected emission shown by arrow 713 which is detected by detector 711.

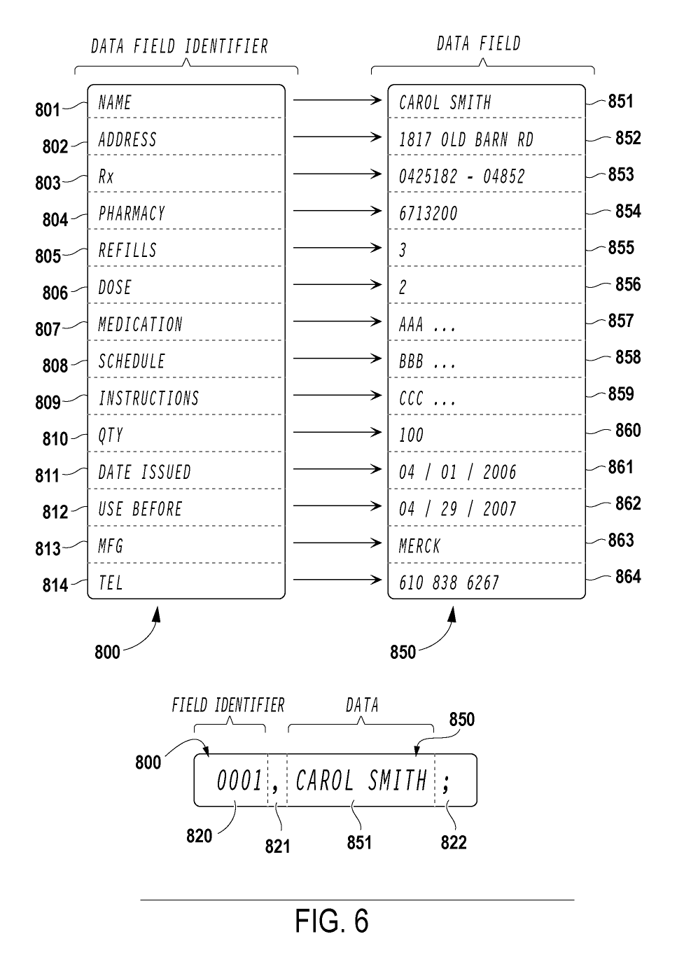

Referring now to FIG. 6, media 720c, which may alternatively described as a readable memory device or memory chip and is a two-dimensional bar code in one embodiment, has a data field identifier list 800 along with a corresponding data field 850. The data field identifier list 800 includes the patient's name (801), address (802), prescription number (“RX”) (803), number of allowed refills (805), dose (806), description of the medication (807), dispensing encoded schedule (808), special medication instructions (809), initial quantity (810), medication issue date (811), medication use-before date (812), medication manufacturer (813), and pharmacy telephone number (814). Other data field identifiers such as expiration date, etc. can be added or data identifiers deleted.

Respective data fields 851-864 represent alpha-numeric data corresponding to each respective data field identifier 800. Each data identifier 800 is digitally encoded with a four-digit binary code. For example, the data identifier 801 “NAME” is encoded onto media 720c as the binary code 820 “0001”; followed by a delimiter 821 (in this case a colon); followed by the corresponding alpha numeric data field 851 “CAROL SMITH”; followed by a different delimiter 822 (in this case a semicolon). The next data identifier would follow delimiter 822 etc. thus forming a serial string of data identifiers and data fields. Data fields 857, 858 and 859 contain codes which relate to various predetermined data. For example, data field 857 could be encoded as a hexadecimal binary string 020 which could represent amoxicillin 500 mg. Likewise, data field 858 could be encoded as a hexadecimal binary string 010 which could represent the dispensing schedule “every 4 hours.” Further, data field 859 could be encoded as hexadecimal binary string 110 which could represent “take with food” or another special instruction. The encoded data fields are intended to exemplary only and various other designations may be used. Thus these codes have been pre-established and are known at the time the exemplary two-dimensional bar code is printed. When appropriate, information contained in the data fields 851-864 can be displayed to the user on the LCD screen 220.

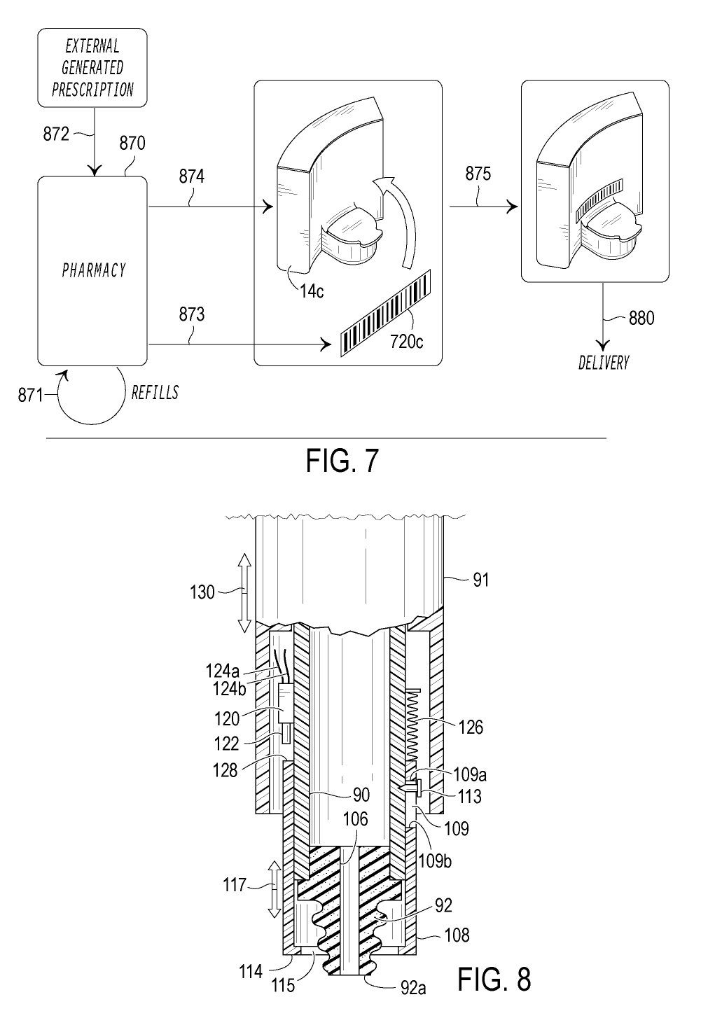

FIG. 7 illustrates the process of preparing pill dispensing container 14c for shipment to the patient. A pharmacy, represented by block 870, either receives an external doctor-generated prescription request (arrow 872) or a refill request (arrow 871). The doctor or pharmacist then loads the required amount of medication (arrow 874) into pill dispensing chamber portions 22c, 24c and places the top 16c and seal 725c onto filled container 14c (see FIG. 2). Data is entered into a computer (not shown), which then prints a two-dimensional bar code 720c having all of the necessary data field identifiers and data fields encoded thereon (arrow 873), which is then affixed to the container 14c (arrow 875).

Various methods may be used to enter the data into the computer. The data may include various types of information such as dosage amount, dosage schedule and the previously described data fields (see FIG. 4) that may be stored on two-dimensional bar code 720c. The two-dimensional code is then placed onto container 14c, which is then packaged and shipped to the patient, as represented by delivery arrow 880.

If flash-memory media is used instead of a bar code 720c, the media could be permanently attached to the container 14c. In this case, the doctor or pharmacist would use an interface suitable to the type of media used (e.g., a USB or serial interface) to load dosage information onto the media prior to shipment to the patient.

Referring to FIG. 8, a more detailed illustration of assembly 91 is shown having bellows 92 inserted into conduit 90. Bellows 92 has a central open conduit 106. Thus fluid communication is continuous from the bottom tip of 92a of bellows 92 to port 72 of vacuum pump 70 (see FIG. 2). Placed along the outside of conduit 90 is moveable sheath 108. Formed on the side of sheath 108 is slot 109. A pin 113 is inserted through slot 109 and is attached to the side of conduit 90. Sheath 108 is free to move vertically a predefined distance as shown by arrows 117. The extent of vertical movement is defined by the top end 109a and the bottom end 109b of slot 109. The bottom 114 of sheath 108 has an opening 115 which allows bellows 92 to freely protrude through and past bottom 114 of sheath 108.

Fixed to the outside wall of conduit 90 is a push button single pole single throw sheath limit switch 120. Button 122 when depressed into the body of switch 120 closes the switch which is connected to printed circuit board 68 via leads or electrical conduits 124a, 124b.

The upper end of compression spring 126 is attached to conduit 90 with the lower end of spring 126 engaging the upper edge 128 of sheath 108. Thus sheath 108 is biased in the extended position with pin 113 engaging the top end 109a of slot 109. It is thus understood that assembly 91 moves in a vertical direction as depicted by arrows 130 independent of movement of both sheath 107 and bellows 92.

Referring now to FIG. 9, an electrical block diagram of pill dispenser 1 is shown to include a controller (microcontroller μc 200), in electrical, bidirectional communication with single board computer 210 via bus 206. Other controllers and other computers may also be used. The terms controller and microcontroller may be used interchangeably hereinafter.

Microcontroller 200 has random access memory (RAM) 201 and flash memory 202. Memory 201 temporarily stores information received by computer 210. Memory 202 contains a dispensing algorithm used to control the dispensing of medication stored in pill dispensing containers 14. It is understood that any suitable microcontroller having the required computing resources may be used as microcontroller 200. Computer 210 is in bidirectional electrical communication via bus 215 with touch screen LCD 220 but other programming means such as a keyboard may be used. User input and output communication 222 with computer 210 is via the touch screen and the LCD display panel respectively, both of which are incorporated into LCD screen 220. Additionally, computer 210 is in electrical communication with bar code reader 710.

Microcontroller 200 is in further electrical communication with solenoid valve 78, dispensing motor 98, vibration motors 105 and 107, platform rotation motor 63, vacuum motor 71, pressure transducer 80, solenoid locking latches 890a through 890f, switches 700a through 700f, sheath limit switch 120, limit switches 100 and 102, and optical emitter 10a and optical detector 110b of assembly 110. Power supply 230 supplies the necessary electrical power to all electrical block components shown in FIG. 7. It is further understood that the necessary interface power circuitry for controlling the various motors from the microcontroller control signals is well known in the art and is therefore not included in FIG. 7.

Computer 210 may advantageously be a single board computer, for example an Applied Data Systems part number AGX system having a 32 bit digital Xscale PXA250 RISC INTEL processor running at 400 MHz, 64 Mbytes of 100 MHz SDRAM, 128 Kbytes of EPROM, 64 Mbytes of synchronous flash memory, an Ethernet 10/100BT interface, 22 digital I/O lines, three RS-232 serial ports, SPI communication port, real time clock and other peripherals.

Opto-emitter 110a emits infrared radiation 110a which is reflected off of the surface of semi-reflective strip 112 and received by opto-detector 110b. Strip 112 contains non-reflective bar 112a and reflective bar 112b. The relative position of assembly 110 with respect to strip 112 determines whether radiation 110a is either reflected or absorbed respectively by bars 112b or 112a, and therefore received by opto detector 110b.

Microcontroller 200 receives signals from switches 700a through 700f and is coupled to solenoid locking latches 890a through 890f. Computer 210 is coupled to and receives signal 715 from reader 710 which includes laser emitter 711 and detector 712. In one exemplary embodiment, microcontroller 200 may activate solenoid locking latches 890a through 890f based on received signals from switches 700a through 700b, respectively. Additional details of the interaction between single board computer 210, microcontroller 200, the solenoid locking valves, the solenoid switches and reader 710 are provided below.

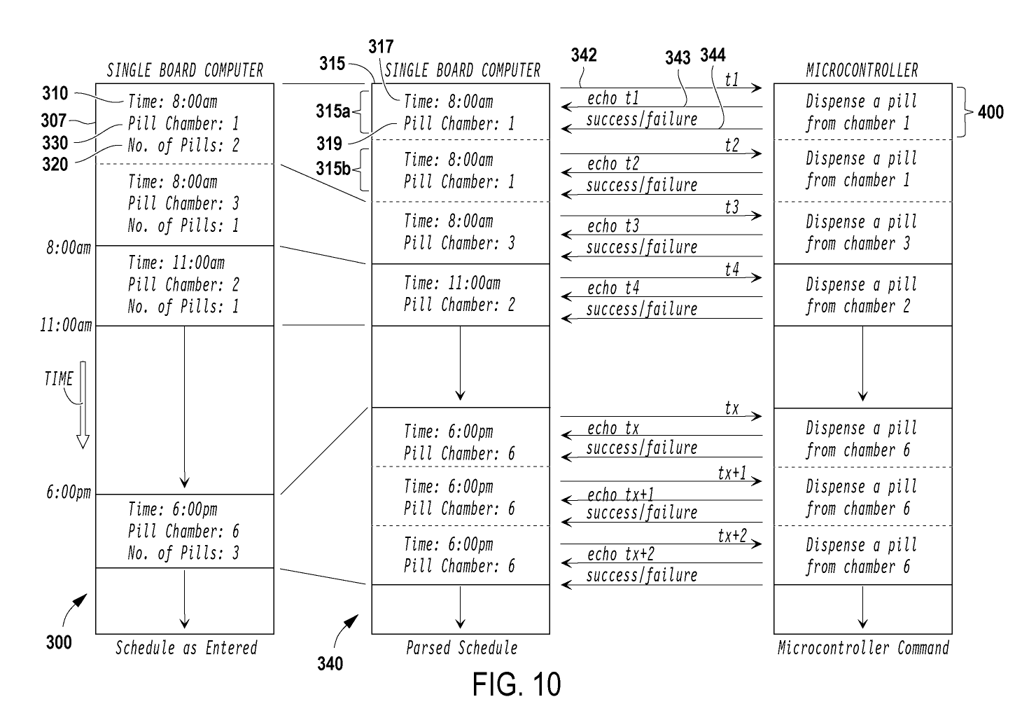

Referring to FIG. 10, for manual entry of the dispensing schedule the user enters the amount of medication and the time for dispensing the medication as more fully described in aforementioned U.S. patent application Ser. No. 11/088,385. Computer 210 receives this information via touch screen LCD 220 and generates a dispensing schedule 300. Schedule 300 is comprised of a sequence of time ordered dispensing time blocks 307. Each time block 307 is comprised of the dispensing time 310, pill chamber identification number 330 and the number of pills 320 which should be dispensed at time 310.

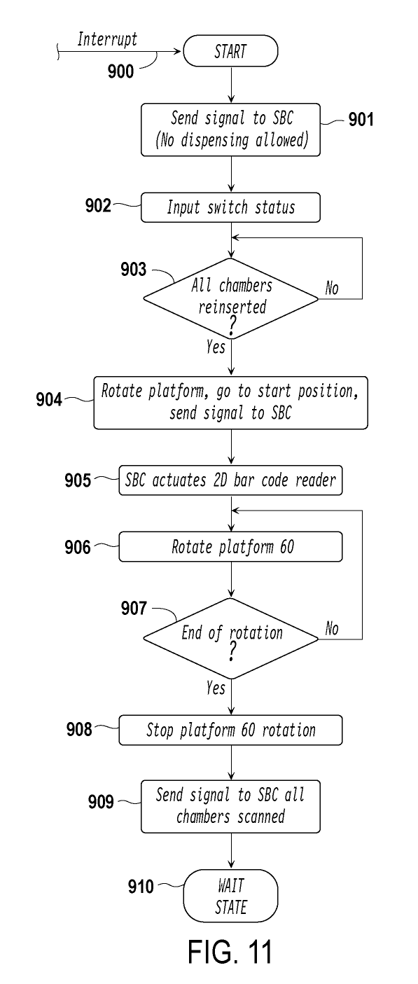

Referring to FIG. 11, dispensing schedule 300 can also be automatically obtained or updated from data read from the data storage media according to the sequence illustrated in FIG. 11. The data obtained from the media 720c in FIG. 11 may then update, i.e., override data previously programmed using conventional manual programming means according to an exemplary embodiment.

As above, microcontroller 200 is in electrical communication with switches 700a though 700f. If one or more dispensing containers 14a through 14f are removed, the respective switch 700a through 700f for that chamber opens sending a corresponding interrupt signal 900 to microcontroller 200. In step 901, microcontroller 200 sends a signal to single board or other computer 210 indicative of the presence of the pill dispensing containers. If one or more containers 14a through 14f have been removed, all further dispensing cycles are suspended. Program flow continues to step 902.

In step 902, controller 200 continually inputs the signals from switches 700a through 700f and determines which container(s) 14a through 14f have been removed. This information will be sent to single board computer 210 in step 909. Program flow then continues to step 903.

In step 903, controller 200 continually inputs the signals from switches 700a through 700f and continually checks if any removed containers have been re-inserted. If all containers are in place or have been re-inserted, program flow continues to step 904.

In step 904, controller 200 rotates platform 60 to a start scan position and sends a signal to computer 210 that platform 60 is in the start scan position. Program flow then continues to step 905.

In step 905, computer 210 activates reader 710 and then sends a signal to controller 200 to begin rotating platform 60. Program flow then continues to step 906.

In step 906, controller 200 rotates platform 60 and determines the angular position of platform 60 by reading bar code 112. Controller 200 continues to rotate platform 60 and sends the corresponding container location, obtained from bar code 112, to computer 210. As platform 60 rotates, reader 710 reads the respective media 720a through 720f. Computer 210, which may be a single board computer, has a one to one correspondence between chamber location and the corresponding information on the media. Controller 200 continually checks for the last chamber in step 907 using the semi-reflective strip 112 and knowing the total number of dispensing chambers. Program flow then continues to step 908.

In step 908, controller 200 stops the rotation of platform 60. At the end of platform 60 rotation, all of the data storage media have been read by computer 210. Program flow then continues to step 909.

In step 909, controller 200 then sends a signal to computer 210 that all media have been scanned. Controller 200 then enters a wait state in step 910.

Computer 210 then constructs dispensing schedule 300 based on the data read from the media 720a through 720c and subsequently stores data field identifier 800 and data field 850 information (see FIG. 6) along with the corresponding container 14a through 14f. If a dispensing schedule 300 had existed previously, the signal sent at step 909 may update or override the previously existing dispensing schedule 300. Also, computer 210 uses the data field 850 information to perform checks on drug compatibility between all medications stored within dispensing containers 14a, 14b and to further check that all medication stored within the pill dispenser corresponds to a single patient.

For either manual or automatic entry of the dispensing schedule, computer 210 further parses schedule 300 into parsed schedule 340 as in FIG. 10. Parsed schedule 340 is further comprised of a sequence of individual time ordered dispensing blocks 315. Each block 315 contains the time 317 along with a single pill dispensing instruction 319. Thus, time block 307, which requires two pills from chamber 1, is parsed into two blocks 315a and 315b each of which contains an individual instruction for dispensing a single pill from pill chamber 1. Computer 210 then compares the real time clock time with time 317 and if a match occurs, begins the transfer of the dispensing instruction 319 to the microcontroller via bus 206 at time t1 342. Thus the microcontroller is instructed to only dispense one pill at a time by computer 210. Dispensing instruction 319 contains the desired pill container 14 which stores the pills.

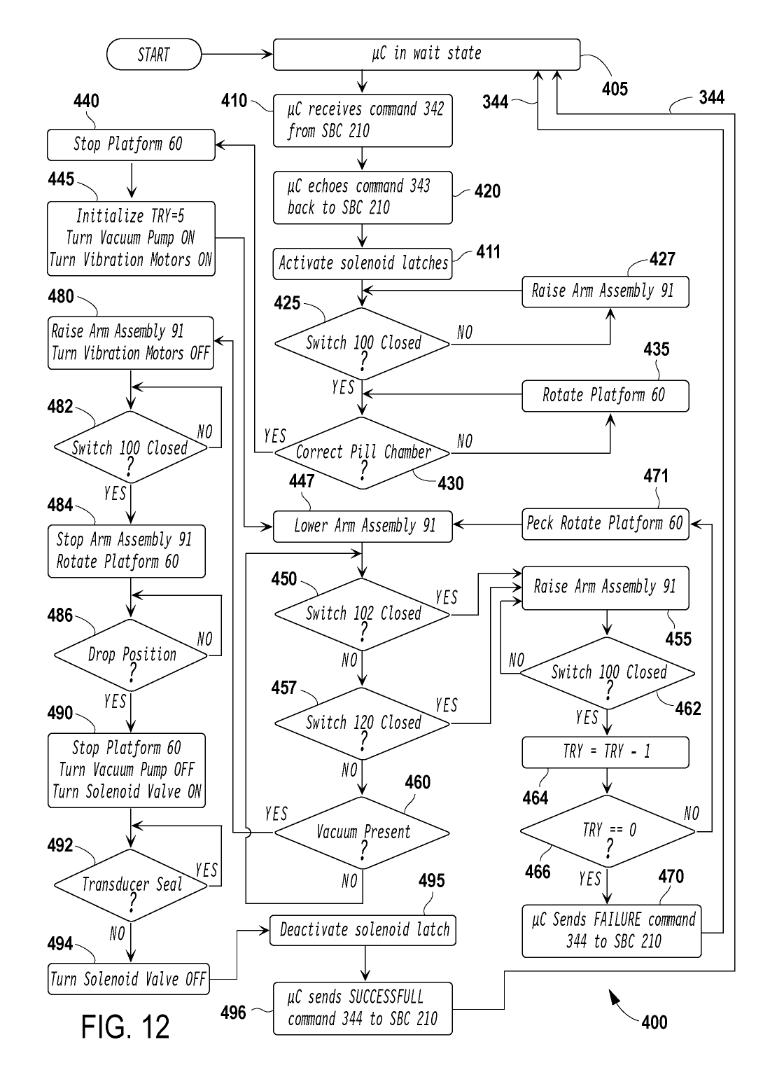

Referring to FIG. 12, upon receiving a dispensing command 319 from computer 210, the microcontroller (μC) begins execution of the dispensing algorithm 400. Before receiving the dispensing instruction 319, the microcontroller is held in wait state 405. At step 410, the microcontroller receives dispensing command 319 from computer at time t1 342 and then at step 420 echoes back the received command 343 to computer 210. The microcontroller then activates the solenoid lock latches 890a through 890f in step 411, locking all containers 14a through 14f into base 10 and preventing their removal.

Computer 210 then compares the echoed back command with the original command 319 and either issues an error and stops dispensing or allows the microcontroller to proceed to step 425. In step 425, the microcontroller inputs the voltage on line 230a and checks whether switch 100 is closed. If switch 100 is not closed, the microcontroller outputs a command to motor 98 in step 427 to turn pinion 96 in a clockwise direction raising rack 94 and therefore assembly 91. Motor 98 is continuously powered until switch 100 closes. In response to switch 100 closing, the microcontroller or controller 200 shuts off motor 98 in step 425 stopping the upward vertical movement of rack 94.

Having positioned rack 94 in the most upward vertical position indicated by switch 100 closing, the microcontroller then activates opto emitter 110a. Opto emitter 110a emits radiation 111a which is either reflected or absorbed by strip 112. The reflected energy 111b activates opto detector 110b which sends a signal indicating the current position of platform 60 with respect to the desired container 14 previously received by microcontroller 200 from computer 210 in instruction 342. In step 435, microcontroller 200 then energizes motor 63 which in turn rotates platform 60. As platform 60 rotates, the relative position of platform 60 with respect to the containers 14a through 14f is communicated to microcontroller 200 by optical assembly 110 and strip 112. When platform 60 is aligned with the selected container 14c having aperture 61a over dispensing chamber portion 24c (step 430), microcontroller 200 in step 440 sends a command to stop motor 63. Aperture 61a is now centrally aligned over aperture 20c, allowing assembly 91 access to pills 30 contained within chamber portion 24c (see FIG. 2). All other pill chamber access apertures 20a, 20b, 20d, 20e, 20f are covered by platform 60. Program flow then continues to step 445.

In step 445, microcontroller 200 initializes a RAM 201 memory register variable TRY to 5. Microcontroller 200 additionally turns on both pump motor 71 and vibration motors 105 and 107. Program flow then continues to step 447.

In step 447, microcontroller 200 turns on motor 98 which now rotates in a counter clockwise direction lowering assembly 91. Assembly 91 now begins a vertical downward decent through aperture 61a, through hole 20c and into dispensing chamber portion 24c. Program flow now continues to step 450.

In step 450, microcontroller 200 inputs the signal on line 102a from switch 102. If line 102a is at a logic high indicating a switch 102 closure, program flow now proceeds to step 455 where microcontroller 200 immediately reverses the direction of motor 98 to rotate in a clockwise direction thus raising assembly 91. Switch 102 closure indicates that assembly 91 is at the furthermost allowed vertical decent into chamber portion 24c. This occurs, for example, when pill chamber portion 24c is empty. Program flow then proceeds to step 460. If switch 102 is not closed, program flow continues to step 457.

In step 457, microcontroller 200 inputs the signal on line 120a and checks the state of switch 120. If switch 120 is closed, program flow continues back to step 455. If switch 120 is not closed, program flow continues to step 460.

In step 460, microcontroller 200 inputs a signal from pressure transducer 80. If bellows 92 has engaged a pill in chamber portion 24c creating a vacuum seal in the fluid circuit, transducer 80 senses an increase in the vacuum pressure. Program flow then continues to step 480. If the signal from transducer 80 indicates the absence of a vacuum seal, program flow loops back to step 450.

In this embodiment, steps 450, 457 and 460 are set up in a polling configuration, meaning that the microcontroller 200 cycles “polls” the input signals sequentially. The preferred polling rate for each of these steps is a function of the speed at which the bellows 92 is lowered. Alternatively, an interrupt configuration could be used instead of the polling configuration for steps 450, 457 and 460.

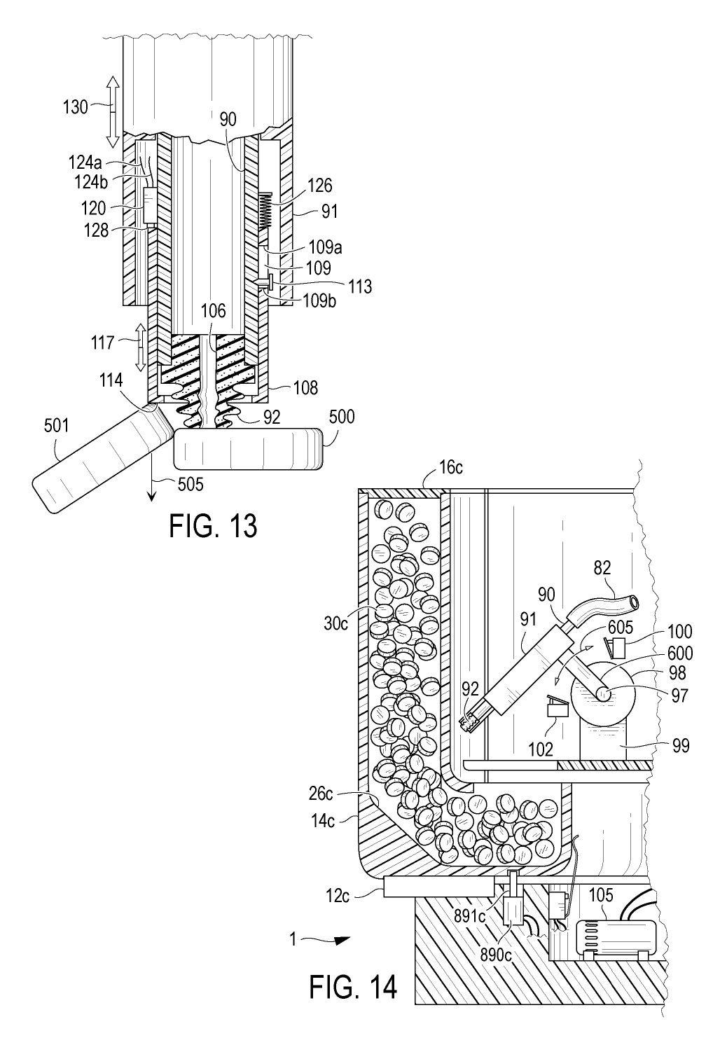

Referring to FIG. 13, bellows 92 is shown engaging the top surface of pill 500. Bellows 92 deforms to the surface topology of pill 500 and would normally create a vacuum seal. However, there are instances where bellows 92 is fully deformed and yet a vacuum seal is not formed. This situation may arise if bellows 92 engages a pill edge thereby having conduit 106 partially open to atmospheric pressure thus preventing a vacuum seal from forming. With bellows 92 fully compressed and a vacuum seal not formed, sheath 108 begins to move upwardly against the force of spring 126 and switch 120. Eventually switch 120 closes preventing the further downward movement of assembly 91 and the possible crushing or otherwise breakage of pills located beneath assembly 91. Further, the downward force of sheath 108 created by the force produced by compressing spring 126 acting on sheath 108 produces a downward directed force shown by arrow 505 on surrounding pill 501 forcing pill 501 away from bellows 92.

Referring again to FIG. 12, in step 462, microcontroller 200 inputs signal on line 100a and checks if switch 100 is closed. If switch 100 is closed, program flow continues to step 464. If switch 100 is open, program flow continues to step 466.

In step 464, microcontroller 200 turns on motor 98 in the counter clockwise direction lowering assembly 91. Additionally, the variable TRY is decremented by 1. Program flow then continues to step 466.

In step 466, microprocessor 200 compares the current value of variable TRY to 0. If TRY=0, program flow continues to step 470. In step 470, microprocessor 200 sends failure message 344 to computer 210 indicating that a failure has occurred after five attempts of picking up a pill. If TRY does not equal 0, the platform 60 is rotated a small amount (step 471, called a “peck” rotation) and program flow loops back to step 450. The TRY variable can be set to any value and for illustrative purposes has been set equal to five.

The “peck” rotation of the platform 60 executed in step 471 means that each successive lowering of the bellows 92 into the dispensing chamber 24c will occur at slightly different location. This increases the likelihood that the bellows 92 will successfully pick up a pill. The circumferential movement of the bellows 92 in a peck rotation is preferably a relatively small fraction of the width of the dispensing chamber 24c. Peck rotations of 1-5 degrees has been found to be appropriate.

Referring now to step 460, if bellows 92 picks up a pill, a vacuum is established in the fluid circuit and transducer 80 sends a signal to microcontroller 200. Program flow then continues to step 480.

In step 480 and in response to transducer 80 signal, microcontroller 200 turns on motor 98 raising assembly 91. In addition, vibration motors 105 and 107 are shut off. Program flow then continues to step 482.

In step 482, microcontroller 200 inputs signal on line 230a and checks for switch 100 closure. Upon switch 100 closure, program flow continues to step 484. In step 484, microcontroller 200 turns off motor 98 thus stopping the vertical movement of assembly 91 and then turns on motor 63 rotating platform 60. Program flow then continues to step 486.

In step 486, microcontroller 200 inputs the signal from opto-detector 110b and determines if platform 60 is in a “drop position.” When the drop position is reached, program flow proceeds to step 490.

In step 490, microcontroller 200 turns off motor 63 which stops the rotation of platform 63. Microcontroller then turns off pump motor 71 stopping the production of the vacuum in the fluid circuit. Additionally, to quickly release the vacuum and subsequently release the pill, microcontroller 200 turns on solenoid value 78 which allows the fluid circuit to be placed in fluid communication with the atmosphere. The previously held pill is now released and falls under the force of gravity from bellows 92. Program flow continues to step 492.

In step 492, microcontroller 200 inputs the signal from pressure transducer 80 and determines if the fluid circuit still maintains a vacuum. Microcontroller 200 then waits until the vacuum is dissipated and then program flow continues to step 494. In step 494, microcontroller 200 shuts off solenoid valve 78 blocking the atmospheric pressure from the fluid circuit through port 79b. Program flow continues to step 495.

In step 495, microcontroller 200 deactivates the solenoid latches 890a-890f enabling the dispensing containers to be removed from base 10. Program flow then continues to step 496.

In step 496, microcontroller sends a success command 344 back to computer 210 via bus 206. Microcontroller 200 then is placed into a wait state in step 405 where it is ready to accept the next sequenced parsed command 315b from computer 210.

In this embodiment of the invention, the drop position referred to in relation to step 486 is any rotational position in which the bellows 92 is not positioned over one of the dispensing chambers 24a through 24f. Referring again to FIG. 1, a tray 15 is provided and is sloped toward a release tray (not shown) located beneath dispensing chamber 24e. When a pill is dropped from the bellows 92, it will roll in the direction of the arrows 15c shown in FIG. 1 and into the release tray. In order to access the dispensed pills, the user opens a drawer 15a. Opening of the drawer 15a preferably triggers release of the pills from the release tray into the drawer 15a. Alternatively, the tray 15 and the pill dispensing chamber 14e located above the release tray could be omitted. In this case, the only proper drop position would be when the bellows 92 is located over the release tray.

Referring to FIG. 14, dispensing algorithm 400 can also dispense pills using a radial arm for moving dispensing assembly 91 instead of a rack and pinion system. The embodiment of the invention shown in FIG. 14 is otherwise identical to the embodiment shown in FIG. 2. Parts that are identical to those included in the embodiment shown in FIG. 2 are labeled with the same reference numerals in FIG. 14. As illustrated in FIG. 14, a radial arm 600 is attached to shaft 97 of motor 98 which is attached to assembly 91. Limit switches 100 and 102 are now positioned to engage and limit the radial movement 605 of arm 600.

While specific embodiments of the invention have been described in detail, it will be appreciated by those skilled in the art that various modifications and alternatives to these details could be developed in light of the overall teachings of the disclosure without deviating from the spirit and scope of the invention. Furthermore, all examples and conditional language recited herein are principally intended expressly to be only for pedagogical purposes and to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. For example, an AC powered motor could be used in place of DC motor 98. Additionally, the number of containers could be either increased or decreased by suitably tailoring the circumference of base 10. The orientation, shape, and relative position of the containers and chambers and their orientation with respect to base 10 may also be varied in other exemplary embodiments of the invention.

This description of the embodiments herein is intended to be read in connection with the figures of the accompanying drawing, which are to be considered part of the entire written description. In the description, relative terms such as “lower,” “upper,” “horizontal,” “vertical,” “above,” “below,” “up,” “down,” “top” and “bottom” as well as derivatives thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

Although the invention has been described in terms of various embodiments, it is not limited thereto. Rather, the appended claims should be construed broadly, to include other variants and embodiments of the invention, which may be made by those skilled in the art without departing from the scope and range of equivalents of the invention.

What is claimed is:

1. A pill dispensing system comprising:
at least one container including a pill chamber having an opening;
a media attached to the container, the media including machine-readable data;
a mechanism for removing pills from the pill chamber through the opening;
a computer adapted to store the data and direct the mechanism to dispense pills from the pill chamber based on the data; and
an interface configured to transmit the data from the media to the computer

2. The pill dispensing system of claim 1, wherein the data comprises dosage information including at least one of dosage amount, dosage time, and dosage frequency.

3. The pill dispensing system of claim 2, wherein the mechanism dispenses pills from the pill chamber according to a dispensing schedule set by the computer and the dispensing schedule corresponds to the dosage information.

4. The pill dispensing system of claim 1, wherein the computer is programmed to accept dosage information provided to the computer through an input device.

5. The pill dispensing system of claim 4, wherein the computer is programmed to override dosage information provided to the computer through an input device with dosage information provided from the media.

6. The pill dispensing system of claim 1, wherein the data includes at least one of patient name, patient address, pharmacy name, number of refills, dose, medication type, dispensing schedule, instructions for taking medication, quantity of pills, date issued, medication expiration date, manufacturer, and telephone number.

7. The pill dispensing system of claim 1, wherein the media comprises an RFID tag.

8. The pill dispensing system of claim 1, wherein the media comprises a bar code.

9. The pill dispensing system of claim 8, wherein the interface comprises an infrared bar code reader.

10. The pill dispensing system of claim 1, wherein the computer directs the mechanism via a controller.

11. The pill dispensing system of claim 1, wherein the at least one container comprises a plurality of containers, each of the plurality of containers includes a media attached thereto, and the interface is adapted to transmit data from each of the media to the computer.

12. The pill dispensing system of claim 11, wherein the computer is programmed to identify drug interactions between pills contained within any of the plurality of containers.

13. The pill dispensing system of claim 11 wherein each of the plurality of containers is removable from a base, and the pill dispensing system further comprises a plurality of switches, each corresponding to one of the plurality of containers and adapted to send a signal to a controller indicating whether a corresponding one of the plurality containers is installed in the base.

14. The pill dispensing system of claim 1, further comprising a base unit into which each of the at least one containers can be inserted and removed and a solenoid having a locked position that prevents removal of the at least one container from the base unit.

15. The pill dispensing system of claim 14, wherein the computer is programmed to direct a controller to move the solenoid to the locked position after the interface reads the media.

16. The pill dispensing system of claim 1, wherein the pill chamber is adapted to contain a plurality of loose, randomly-oriented pills.

17. The pill dispensing system of claim 16, wherein the dispensing mechanism is adapted to withdraw a pill from the pill chamber by grasping the pill from above.

18. A container for use with a programmable pill dispenser having a dispensing mechanism, a computer and an interface, the container comprising:
a chamber adapted to contain loose, randomly-oriented pills;
at least one chamber opening, sized to accept the pills and adapted to allow the dispensing mechanism to remove a pre-determined number of the pills from the chamber; and
a media that is readable by or through the interface, the media containing dosage information for the pills.

19. The pill dispensing system of claim 18, wherein the dosage information comprises at least one of dosage amount, dosage time, and dosage frequency.

20. The pill dispensing system of claim 18, wherein the dosage information includes at least one of patient name, patient address, pharmacy name, number of refills, dose, medication type, dispensing schedule, instructions for taking medication, quantity of pills, date issued, medication expiration date, manufacturer, and telephone number.

21. The pill dispensing system of claim 18, wherein the media comprises an RFID tag.

22. The pill dispensing system of claim 18, wherein the media comprises a bar code.

23. A method comprising:
loading pills into a chamber, the chamber being part of a container;
providing dosage information for the pills via machine-readable media that is affixed to the container.

24. The method of claim 23, wherein providing dosage information comprises creating a bar code that contains dosage information for the pills and attaching the bar code to the container.

25. The method of claim 23, wherein providing dosage information comprises loading dosage information onto a media that is already attached to the container.

26. The method of claim 23, wherein the pills each contain at least one pharmaceutical compound and/or dietary supplement.

27. The method of claim 23 wherein providing dosage information comprises providing dosage information including at least one of dosage amount, dosage time, and dosage frequency.

28. The method of claim 23 wherein providing dosage information comprises providing dosage information including at least one of patient name, patient address, pharmacy name, number of refills, dose, medication type, dispensing schedule, instructions for taking medication, quantity of pills, date issued, medication expiration date, manufacturer, and telephone number.
